(19) United States
(12) Patent Application Publication
(10) Pub. No.: US 2003/0007347 A1
(43) Pub. Date: Jan. 9, 2003

(54) Multi-function electric bar lamp

(76) Inventors: Chien-Tung Huang, Kuang-Fu Hsiang (TW); Chun-Chu Lin, Tao-Yuan City (TW); Chun-Liang Lin, Tao-Yuan City (TW)

Correspondence Address: CHIEN-TUNG HUANG, 9F 3R, No. 210, CHUNG HSUEH Rd., TAINAN CITY, TW

(21) Appl. No.: 09/899,735

(22) Filed: Jul. 3, 2001

(51) Int. Cl. F21L 4/04

(52) U.S. Cl. 362/205; 362/202; 362/806; 362/363; 362/253

(57) ABSTRACT

A multi-function electric bar lamp includes a cylindrical housing, a tubular lamp cover thread ably combined with the an upper end of the housing, a cylindrical cap thread ably combined with a lower end of the housing, an LED lamp unit and a battery contained stably in a hollow interior of the housing and the cap. The LED lamp is turned on and off by placing the battery with the positive located up or down in the cap. Further, the housing, the cap and lamp cover may be changed in their shape to alter the use of an electric bar lamp.

### BACKGROUND OF THE INVENTION

This invention relates to a multi-function electric bar lamp, particularly to one possible to be used repeatedly without polluting the environment.

Conventional lighting bars mostly use two kinds of chemicals contained separately in a plastic housing, and mixing the two kinds of chemicals to give out light by forcefully bending the plastic housing After a conventional lighting bar is used up, it has to be discarded to make up pollution to the environment.

### SUMMARY OF THE INVENTION

One purpose of the invention is to offer an electric bar lamp possible to change its use and used repeatedly.

The feature of the invention is a cylindrical housing having a hollow interior to contain an LED lamp unit and a battery therein, and the LED lamp is turned on or off by changing the direction of the battery. Further, a cap and a lamp case are changeable to change the use of the bar lamp.

### BRIEF DESCRIPTION OF DRAWINGS

FIG. 1 is an exploded perspective view of a first embodiment of a multi-function electric bar lamp in the present invention;

FIG. 2 is a perspective view of the first embodiment of multi-function electric bar lamp in the present invention;

FIG. 3 is a cross-sectional view of the first embodiment of multi-function electric bar lamp in the present invention, with an LED lamp lit up;

FIG. 4 is a cross-sectional of the first embodiment of a multi-function electric bar lamp in the present invention, with an LED lamp turned off;

FIG. 5 is a cross-sectional view of a second embodiment of a multi-function electric bar lamp in the present invention;

FIG. 6 is a cross-section view of a third embodiment of a multi-function electric bar lamp in a using condition in the present invention;

FIG. 7 is a cross-sectional view of a fourth embodiment of a multi-function electric bar lamp in a using condition in the present invention;

FIG. 8 is side view of the fourth embodiment of a multi-function electric bar lamp combined in one way in the present invention;

FIG. 9 is an exploded perspective view of a fifth embodiment of a multi-function electric bar lamp in the present invention;

FIG. 10 is a perspective view of the fifth embodiment of a multi-function electric bar lamp in the present invention;

FIG. 11 is a perspective view of a sixth embodiment of a multi-function electric bar lamp in the present invention;

FIG. 12 is an exploded perspective view of a seventh embodiment of a multi-function electric bar in the present invention;

FIG. 13 is a cross-sectional view of en eighth embodiment of an electric bar in the present invention;

FIG. 14 is an exploded perspective view of the ninth embodiment of a multi-function electric bar lamp in the present invention; and,

FIG. 15 is a perspective view of plural LED lamps in the present invention.

### DETAILED DESCRIPTION OF THE PREFERRED EMBODIMENTS

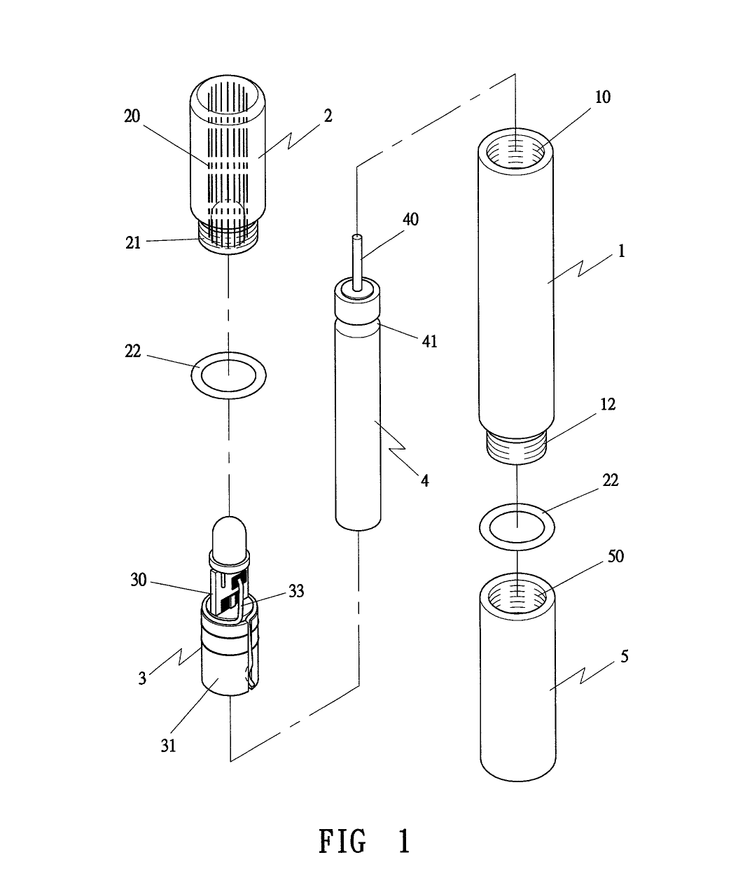

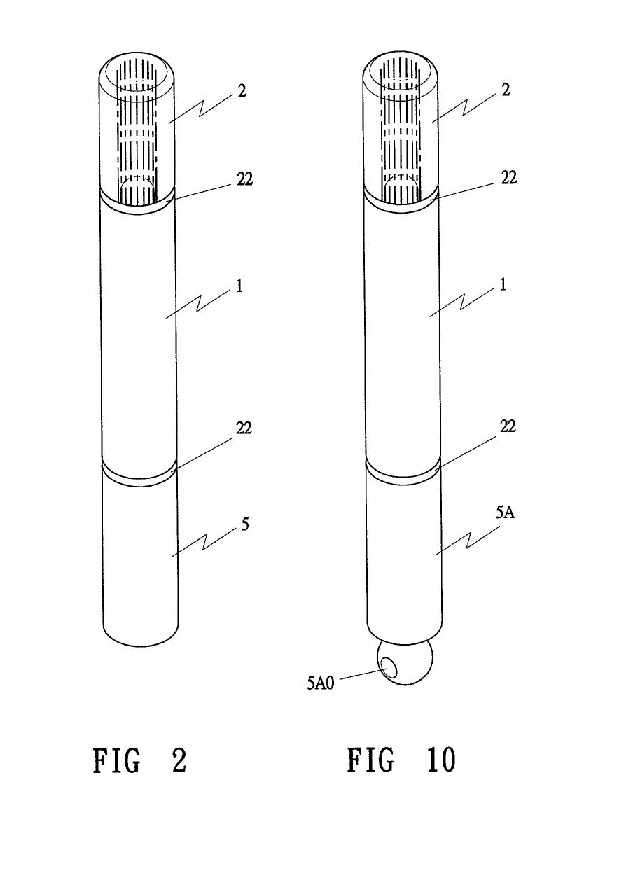

A first embodiment of a multi-function electric bar lamp in the present invention, as shown in FIGS. 1, 2, 3 and 4, includes a housing 1, a lamp cover 2, an LED lamp unit, a battery 4, and a cap 5 as main components combined together.

The housing 1 is cylindrical, having a hollow interior 10, female threaded 11 formed in an upper end and male threads 12 formed in a lower end.

The lamp cover 2 is tubular, having male threads 21 in a lower end to engage with the female threads 11 of the housing I and a plurality of straight cut lines 20 spaced apart around an outer surface for increasing brightness of the LED lamp 3. Further, a ring 22 is fitted around the male threads 21 to prevent water from simmering in the housing 1 after the lamp cover 2 is combined with the housing 1.

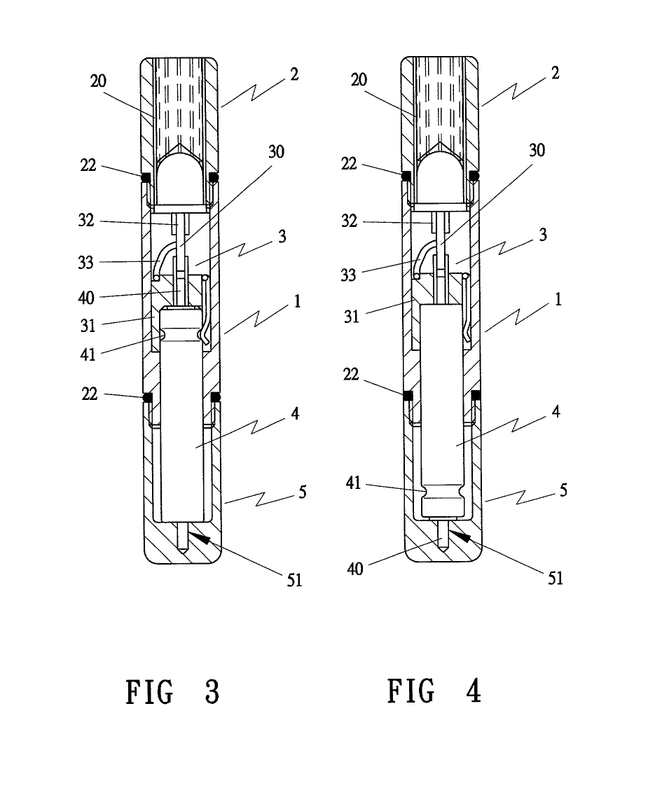

The LED lamp unit 3 is fixed in the hollow interior of the housing 1, having a circuit board 30 fixed on a cylindrical base 31, two pins 32, 33 extending down from the circuit board 30 so as to respectively contact with a positive 40, and a negative 41 of the battery 4 to light up the LED lamp as shown in FIG. 3.

A cap 5 is cylindrical, having female threads 50 in an upper end to engage with the male threads 12 of the housing 1 and a vertical hole 51 formed in the center of a bottom of the cap 5 for the positive 40 of the battery 4 to fit therein for turning on the lamp and to turn off the lamp when the battery 4 is placed upside down as shown in FIG. 4. The battery 4 may not be swayed around to produce noise, fixed steady whether the battery 4 is placed with the positive 40 located up or down.

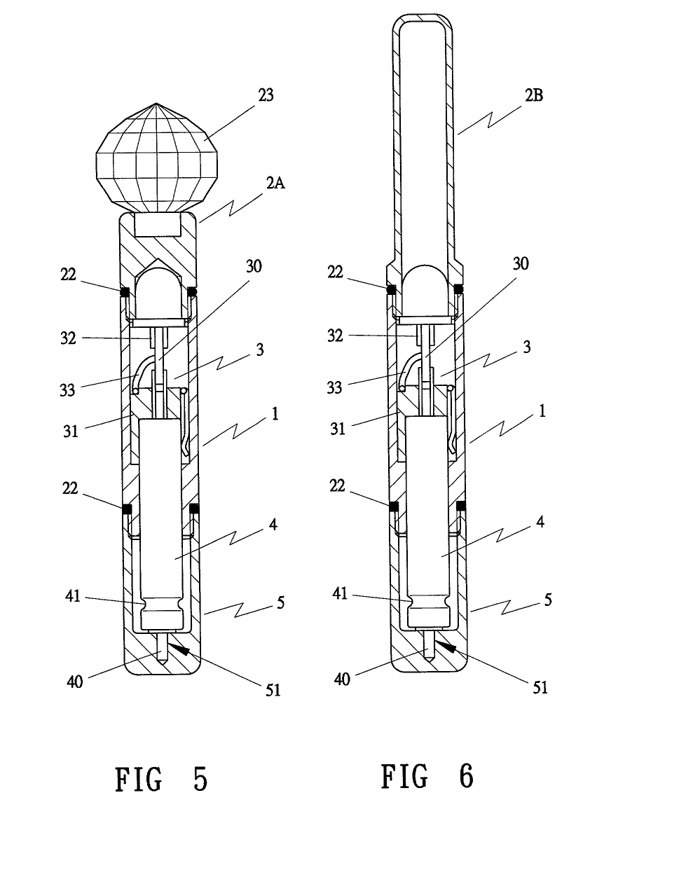

FIG. 5 shows a second embodiment of a multi-function electric bar lamp in the invention, having almost the same structure as the first embodiment, except a crystal ball 23 added on the lamp cover 2A. The second embodiment may be used for occasions of glamorous activities.

FIG. 6 shows a third embodiment of a multi-function electric bar lamp, having also almost the same structure as the first embodiment, except an elongate lamp cover 2B instead of the lamp cover 2 in the first embodiment, usable for occasions of glamorous activities, too.

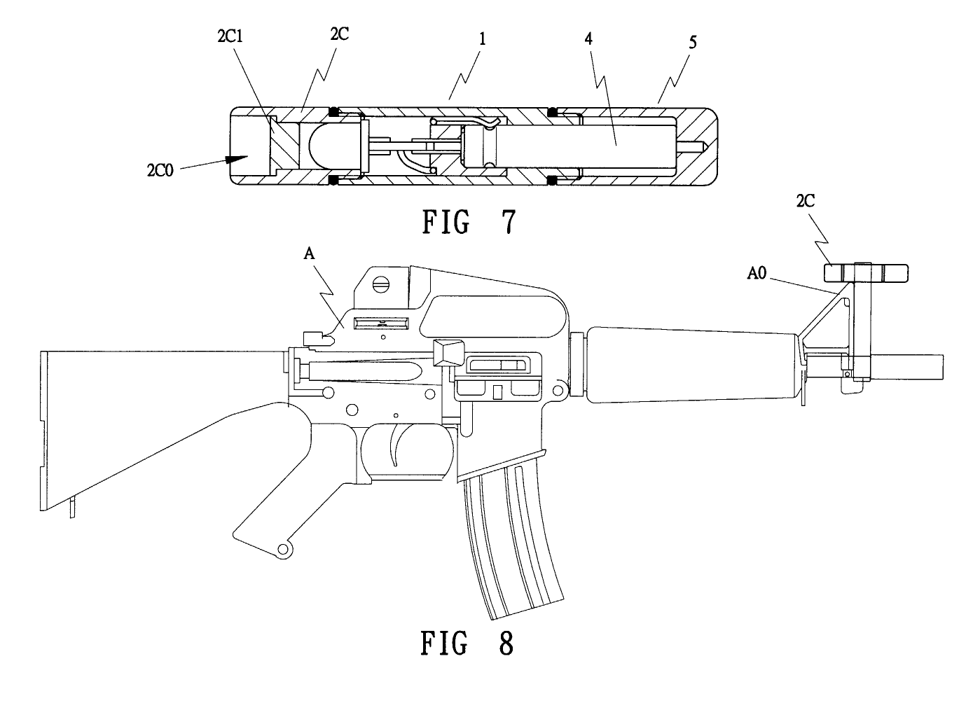

FIGS. 7 and 8 show a fourth embodiment of a multi-function electric bar lamp, having the same structure, except the lamp cover 2C provided with an annular inner recess 2C0 and a light cap 2C1 made of semi-transparent material fitted in the annular inner recess 2C0. Then this bar lamp can be fixed with a sight section AO of a gun (A) for shooting at night.

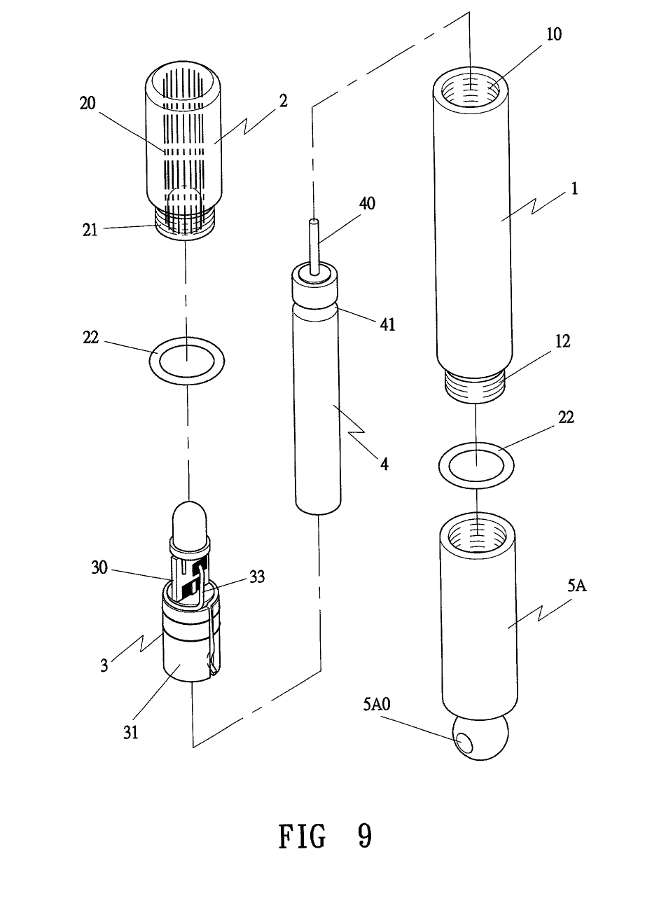

FIGS. 9 and 10 show a fifth embodiment of a multi-function electric bar lamp, having the same structure as the first embodiment, except the cap 5A provided with a ball member with a lateral through hole 5AO. Then the fifth embodiment may be hung on a ring article such as a key holding ring, a hanging embellishment, a necklace, etc.

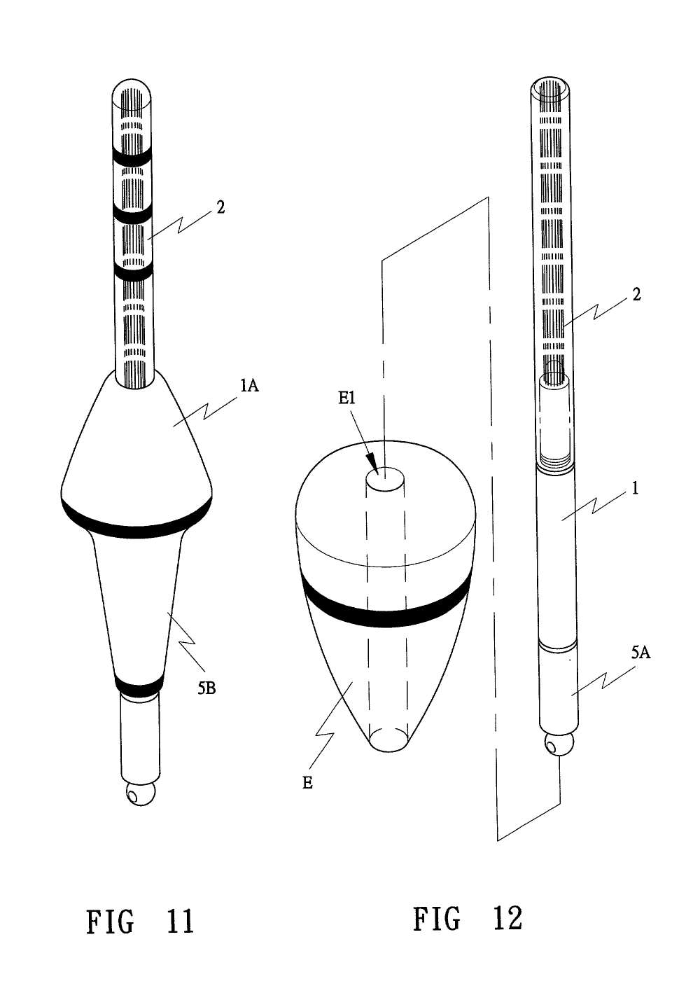

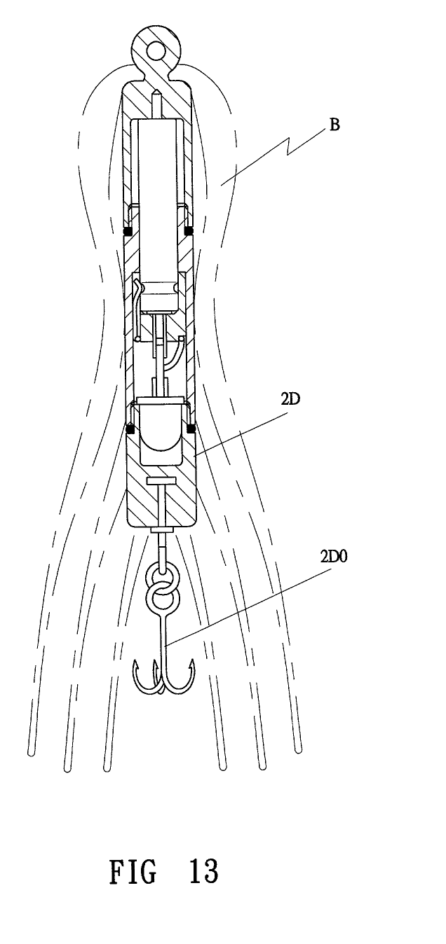

Further, FIGS. 11, 12, and 13 are modified from the fifth embodiment, forming respectively a sixth, a seventh and an eighth embodiment of a multi-function electric bar lamp. The sixth embodiment has a housing 1, a cap 5B and a lamp cover 2C changed in their shape into a float, for fish to gather. The seventh shown in FIG. 12 has a float E with a center vertical hole E1 for the bar lamp inserted therein so as to form a queer shaped float for fish to come and gather around. The eighth embodiment shown in FIG. 13 has a lamp cover 2D provided with a fishhook 2D0 contained in an artificial fly (B) for fishing so as to lure fish with light.

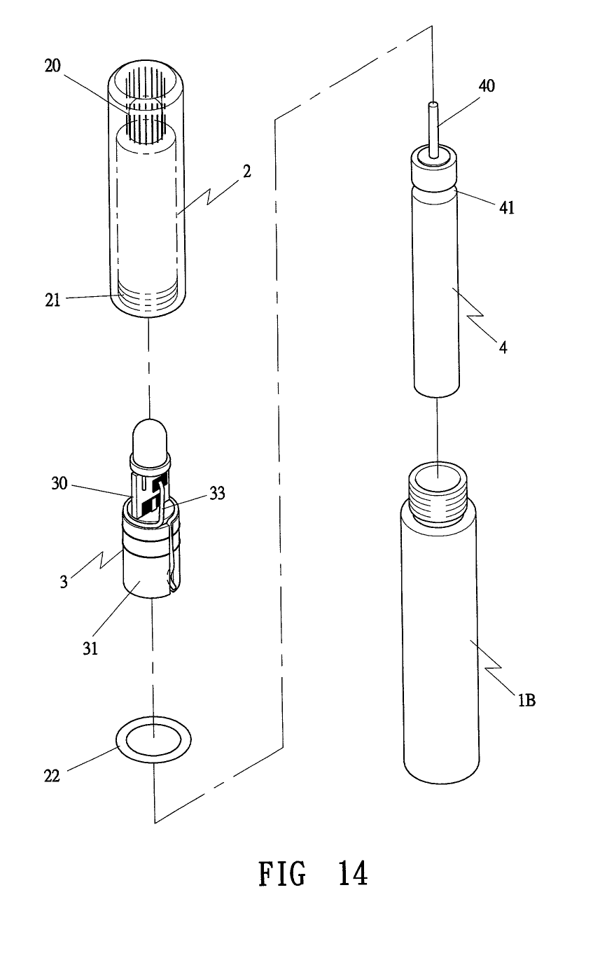

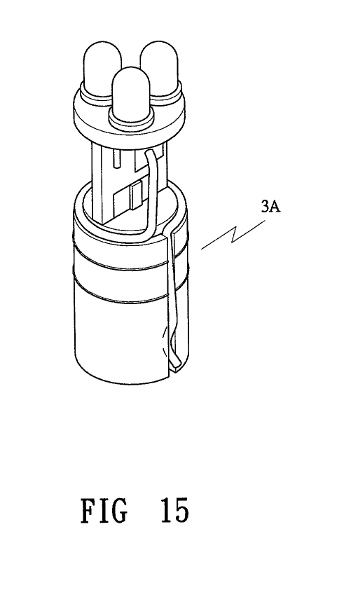

Lastly FIG. 14 shows a ninth embodiment having a housing 1B with a cap formed integral. FIG. 15 shows an LED unit having a plurality of LED lamps fixed on the circuit board for increasing brightness or changing the colors of the LED lamps. Further, the LED lamps may be lit always or flickeringly.

While the preferred embodiments of the invention have been described above, it will be recognized and understood that various modifications may be made therein and the appended claims are intended to cover all such modifications that may fall within the spirit and scope of the invention.

What is claimed is:

1. A multi-function electric bar lamp comprising a cylindrical housing with an hollow interior, female threads formed in an upper end and male threads formed in a lower end, a tubular lamp cover having male threads formed in a lower end and a ring fitting around said male threads, said female threads of said housing engaging with said male threads of said lamp cover to combine said lamp cover with said housing, an LED lamp unit having an LED lamp, a circuit board and a cylindrical base for fixing said circuit board thereon, said LED lamp fixed on said circuit board, said LED unit and a battery contained in said hollow interior of said housing, said LED unit having two conductive pins extending properly to contact respectively with a positive and a negative of said battery, a cap having a cylindrical shape as said housing and female threads formed in an upper end to engage with said male threads of said housing, said cap having a center hole formed in a bottom for said positive of said battery to fit therein, said LED lamp being in turned-ff condition when said battery is placed upside down.

2. The multi-function electric bar lamp as claimed in claim 1, wherein said a crystal ball is attached on said lamp cover.

3. The multi-function electric bar lamp as claimed in claim 1, wherein said lamp cover is lengthened to enable said bar lamp used as a liquor blending bar.

4. The multi-function electric bar lamp as claimed in claim 1, wherein said lamp cover is provided with an annular inner recess, and a light cap made of semi-transparent material is fixed in said annular inner recess, and said electric bar lamp is fixed with a sight section of a gun, functioning as an assistant for night shooting.

5. The multi-function electric bar lamp as claimed in claim 1, wherein said cap is provided with a lateral through hole for hinging said electric bar lamp.

6. The multi-function electric bar lamp as claimed in claim 1, wherein a fishhook is fixed under said lamp cover to form an artificial fly.

7. The multi-function electric bar lamp as claimed in claim 1, wherein said housing and said cap are formed integral.

8. The multi-function electric bar lamp as claimed in claim 1, wherein said LED unit has a plurality of LED lamps to intensify brightness of light and change colors of said LED lamps.

9. The multi-function electric bar lamp as claimed in claim 1, wherein said lamp cover and said cap have different shapes according to demands.

10. The multi-function electric bar lamp as claimed in claim 1, wherein said bar lamp is directly inserted in a through hole in a float for fish to gather around during night.
